(19) United States
(12) Patent Application Publication
(10) Pub. No.: US 2005/0062271 A1
(43) Pub. Date: Mar. 24, 2005

(54) Covering element for airbag system

(76) Inventors: Dieter Heckl, Adelshofen (DE); Joerg Reuter, Heiningen (DE); Alexandra Vogt, Renningen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/492,148

(22) PCT Filed: Oct. 4, 2002
(86) PCT No.: PCT/EP02/11145

(30) Foreign Application Priority Data
Oct. 12, 2001 (DE) 101 50 611.2

(51) Int. Cl. B60R 21/16

(52) U.S. Cl. 280/732

(57) ABSTRACT

A covering for an airbag unit arranged below a panel has at least one predetermined breaking point which is not visible from the vehicle interior provided in the panel for the passage of a deploying airbag. The covering increases the design possibilities for panels in motor vehicles. It is proposed that the panel is covered on its side facing the vehicle interior with a nonwoven textile fabric, the nonwoven textile fabric having, at least in the region of the predetermined breaking point, a textile material of lower tearing strength. According to the invention, threads of lower and higher tearing strength are incorporated in alternating fashion in the textile material.

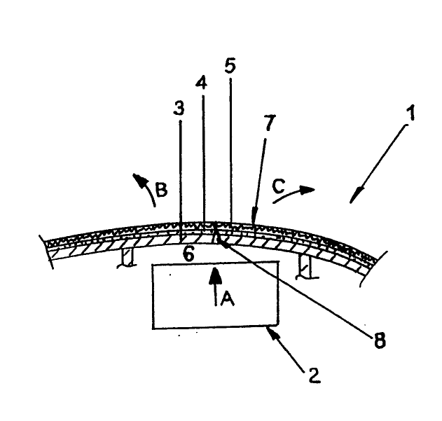

### BACKGROUND AND SUMMARY OF THE INVENTION

This invention relates to a covering for an airbag unit arranged below a panel.

German document DE 198 37 421 A1 discloses an arrangement of this type. In order to permit the passage of an airbag arranged under the panel, at least one predetermined breaking point which breaks open when the airbag is deployed is provided in the panel. For esthetic reasons, it is generally not desirable to see the predetermined breaking point from the vehicle interior, and so it is rendered invisible by means of appropriate measures, for example by introducing the predetermined breaking point from the rear side of the panel.

European document EP 0 943 709 A1 discloses a covering for an airbag unit in which a panel is covered with a nonwoven textile fabric. For passage of the airbag, an invisible predetermined breaking point is provided in the nonwoven textile fabric, the point tearing open at a defined force.

It is an object of the invention to increase the design possibilities for panels in motor vehicles, with predetermined breaking points for airbag units arranged below the panel not being visible as previously from the vehicle interior.

This object is achieved according to the invention by the features claimed.

The design possibilities for panels in which a covering of an airbag unit is integrated are increased in an astonishingly simple manner if the panel is covered with a nonwoven textile fabric, for example with a flat knitted fabric. The diversity of nonwoven textile fabrics enables the surface structure of the panel to be designed in virtually any manner. The use of very different manufacturing possibilities makes it possible to produce nonwoven textile fabrics cost effectively both in terms of surface patterning and also in coloring. For the passage of the airbag, the nonwoven textile fabric is weakened at least in the region of the predetermined breaking point of the panel by textile material of lower tearing strength being incorporated. The textile material covers the surface, and is manufactured entirely from threads of different tearing strength. Threads of lower and higher tearing strength are incorporated in alternating fashion in the textile material. The number of threads and their binding in the textile material are coordinated with each other in such a manner that a nonwoven textile fabric is produced which, although having a low tearing strength overall, is nevertheless designed to be sufficiently durable as a textile cover. The textile material can thus tear when subjected to a defined force, with design possibilities for the nonwoven textile fabric remaining to a sufficient extent because of the incorporation of the threads of higher tearing force. Weakenings are therefore contained uniformly in the textile material, with the result that the mesh fabric can be pulled onto the panel irrespective of the predetermined breaking point of the covering. The binding of the threads to one another is designed in such a manner that thread breakage does not occur during normal operation or loading, i.e. when used as a covering.

The nonwoven textile fabric is advantageously a mesh fabric, i.e. a knitted fabric, and so completely ready-made parts can be produced. This has the advantage that with the elasticity typical for mesh fabrics the completely ready-made parts have an optimum fitting shape, which enables them to be converted into the end product without further processing steps. In addition, virtually any shaping can be produced with the known methods of producing mesh fabrics, such as, for example, knitting, thus enabling the shapes for the panels to be designed independently of the textile cover.

In a preferred embodiment, the panel can be formed as an injection molded part from polypropylene with an EPDM content (ethylene-propylene rubber). A predetermined breaking point can then be introduced from the rear side, it being possible for it to be introduced by laser, for example.

In order to cushion the panel for minor accidents, a nonwoven may be arranged between the mesh fabric and the panel. In order, in this case, to be able to weaken the mesh fabric in the region of the predetermined breaking point, one or more splits may be introduced from the rear side of the panel by laser. The splits completely penetrating the panel and the nonwoven while the nonwoven textile fabric is only partially torn if at all. The splits have a V-shaped cross section and weaken the covering and, if appropriate, the nonwoven in such a manner that the force of the airbag which is effective during its deployment tears open the splits.

The construction of a covering for an airbag unit is explained with reference to the drawing.

### BRIEF DESCRIPTION OF THE DRAWING

The single FIGURE shows a cross section through a panel arranged above an airbag unit.

### DETAILED DESCRIPTION OF THE INVENTION

The single FIGURE shows a cross section through a panel 1 which is arranged above an airbag unit 2. The panel 1 comprises a basic body 3 which is embodied as an injection molded part. An adhesive layer 4 which fixes a flat knitted fabric 5 against slipping is applied to the basic body 3. The flat knitted fabric is a mesh fabric in which warp threads of lower and higher tearing strength are incorporated in alternating fashion.

The airbag unit 2 is arranged in a firing channel 6 which is closed to the outside by a covering 7 formed by the panel 1, as long as the airbag unit 2 is inactive.

A predetermined breaking point 8 which cannot be seen from the vehicle interior is introduced in the covering 7 approximately in the center of the firing channel 6. The predetermined breaking point 8 is introduced from the rear side by laser, i.e. the covering 7 has a material weakening at this point.

If the airbag unit 2 is now activated, then the airbag emerges in the direction of the arrow A and acts upon the predetermined breaking point 8, so that the covering 7 is divided into two and the two parts pivot away around hinges (not illustrated) in accordance with the arrows B and C.

The deploying force of the airbag also acts upon the flat knitted fabric 5. Since the flat knitted fabric 5 is continuously weakened in the region above the predetermined breaking point 8 by incorporation of threads of lower tearing strength, the deploying force of the airbag is sufficient in order to tear through the flat knitted fabric 5 together with the covering 7 and to pivot the covering 7 in accordance with the arrows B and C, so that the path for the airbag is free. The binding of the flat knitted fabric and the choice of material of the warp threads which are used are coordinated as a function of the anticipated penetration force of the airbag.

1-6. (canceled)

7. A covering for an airbag unit arranged below a panel, at least one predetermined breaking point which is not visible from a vehicle interior being provided in the panel for passage of a deploying airbag, comprising a nonwoven textile fabric covering the panel on its side facing the vehicle interior, the nonwoven textile fabric having, at least in a region of the predetermined breaking point, textile material of lower tearing strength, threads of lower and higher tearing strength being incorporated in alternating fashion in the textile material.

8. The covering as claimed in claim 7, wherein the nonwoven textile fabric with which the panel is covered is a mesh fabric.

9. The covering as claimed in claim 8, wherein the panel comprises a basic body which is manufactured as an injection molded part.

10. The covering as claimed in claim 8, wherein a nonwoven is arranged between the panel and the mesh fabric.

11. The covering as claimed in claim 8, wherein the predetermined breaking point is introduced from a rear side of the covering in the form of a split and at most partially penetrates the mesh fabric.

12. The covering as claimed in claim 11, wherein the split is introduced from the rear side of the panel by laser.

13. The covering as claimed in claim 9, wherein a nonwoven is arranged between the panel and the mesh fabric.

14. The covering as claimed in claim 9, wherein the predetermined breaking point is introduced from a rear side of the covering in the form of a split and at most partially penetrates the mesh fabric.

15. The covering as claimed in claim 14, wherein the split is introduced from the rear side of the panel by laser.
